(19) United States
(12) Patent Application Publication
(10) Pub. No.: US 2018/0352154 A1
(43) Pub. Date: Dec. 6, 2018

(54) IMAGE PROCESSING METHOD, ELECTRONIC DEVICE, AND NON-TRANSITORY COMPUTER READABLE STORAGE MEDIUM

(71) Applicant: HTC Corporation, Taoyuan City (TW)

(72) Inventor: Wen-Hsiang YU, Taoyuan City (TW)

(21) Appl. No.: 15/995,148

(22) Filed: Jun. 1, 2018

Related U.S. Application Data
(60) Provisional application No. 62/514,015, filed on Jun. 2, 2017.

(51) Int. Cl. H04N 5/232; G06F 17/30; H04N 5/235; H04N 5/357

(52) U.S. Cl. CPC H04N 5/23229; G06F 17/30268; H04N 5/357; H04N 5/23267; H04N 5/2353

(57) ABSTRACT

An image processing method includes: capturing a first image by a camera at a first timestamp; shifting, by an actuator connected to the camera, a lens of the camera; capturing a second image by the camera at a second timestamp after the first timestamp; performing, by a processing circuit, an image fusion to the first image and the second image to de-noise fixed pattern noises; and generating an output image based on a shift amount of the lens of the camera between the first timestamp and the second timestamp.

### RELATED APPLICATIONS

This application claims priority to U.S. Provisional Application Ser. No. 62/514,015, filed Jun. 2, 2017, which is herein incorporated by reference.

### BACKGROUND

### Technical Field

The present disclosure relates to an electronic device and an image processing method. More particularly, the present disclosure relates to the electronic device and the image processing method related to image fusion.

### Description of Related Art

Nowadays, image fusion methods are used in various applications to improve the quality of the image taken by the camera. For example, High Dynamic Range (HDR) may be applied to obtain more details in the image.

### SUMMARY

One aspect of the present disclosure is related to an image processing method. In accordance with some embodiments of the present disclosure, the image processing method includes: capturing a first image by a camera at a first timestamp; shifting, by an actuator connected to the camera, a lens of the camera; capturing a second image by the camera at a second timestamp after the first timestamp; and performing, by a processing circuit, an image fusion to the first image and the second image to de-noise fixed pattern noises; and generating an output image based on a shift amount of the lens of the camera between the first timestamp and the second timestamp.

Another aspect of the present disclosure is related to an electronic device. In accordance with some embodiments of the present disclosure, the electronic device includes a processing circuit, a camera electrically connected to the processing circuit, an actuator electrically connected to the camera, a memory electrically connected to the processing circuit, and one or more programs. The one or more programs are stored in the memory and configured to be executed by the processing circuit. The one or more programs comprising instructions for: controlling the camera to capture a first image at a first timestamp; controlling the actuator to shift a lens of the camera; controlling the camera to capture a second image at a second timestamp after the first timestamp; and performing an image fusion to the first image and the second image to de-noise fixed pattern noises; and generating an output image based on a shift amount of the lens of the camera between the first timestamp and the second timestamp.

Another aspect of the present disclosure is related to a non-transitory computer readable storage medium. In accordance with some embodiments of the present disclosure, the non-transitory computer readable storage medium stores one or more programs including instructions, which when executed, causes a processing circuit to perform operations including: controlling a camera to capture a first image at a first timestamp; controlling an actuator electrically connected to the camera to shift a lens of the camera; controlling the camera to capture a second image at a second timestamp after the first timestamp; performing an image fusion to the first image and the second image to de-noise fixed pattern noises; and generating an output image based on a shift amount of the lens of the camera between the first timestamp and the second timestamp.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference made to the accompanying drawings as follows:

FIG. 1 is a schematic block diagram illustrating an electronic device in accordance with some embodiments of the present disclosure.

FIG. 2 is a flowchart illustrating an image processing method in accordance with some embodiments of the present disclosure.

FIG. 3A is a diagram illustrating operation of the image processing method according to some embodiments of the present disclosure.

FIG. 3B is a diagram illustrating image histograms of the first image, the second image and the output image according to some embodiments of the present disclosure.

FIG. 4 is a diagram illustrating operation of the image processing method according to some other embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

It will be understood that, in the description herein and throughout the claims that follow, when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Moreover, “electrically connect” or “connect” can further refer to the interoperation or interaction between two or more elements.

It will be understood that, in the description herein and throughout the claims that follow, although the terms “first,” “second,” etc. may be used to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

It will be understood that, in the description herein and throughout the claims that follow, words indicating direction used in the description of the following embodiments, such as “above,” “below,” “left,” “right,” “front” and “back,” are directions as they relate to the accompanying drawings. Therefore, such words indicating direction are used for illustration and do not limit the present disclosure.

It will be understood that, in the description herein and throughout the claims that follow, unless otherwise defined, all terms (including technical and scientific terms) have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any element in a claim that does not explicitly state “means for” performing a specified function, or “step for” performing a specific function, is not to be interpreted as a “means” or “step” clause as specified in 35 U.S.C. § 112(f). In particular, the use of “step of” in the claims herein is not intended to invoke the provisions of 35 U.S.C. § 112(f).

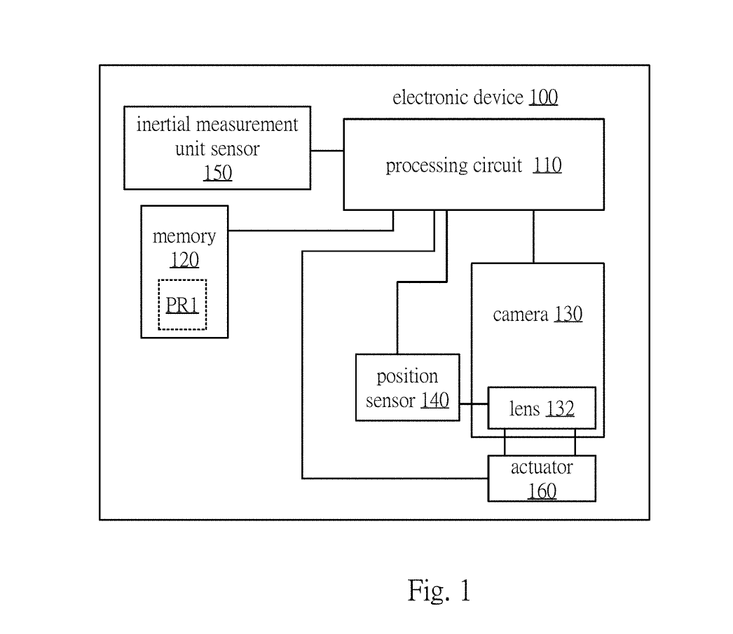

Reference is made to FIG. 1. FIG. 1 is a schematic block diagram illustrating an electronic device 100 in accordance with some embodiments of the present disclosure. The electronic device 100 may be configured to capture a plurality images in sequence, and generate an output image based on the captured images in order to reduce spatial noise, temporal noise and/or fixed pattern noise (FPN). In detail, multiple ADC (Analog-to-Digital converter) amplifiers are respectively arranged on pixels of CMOS image sensor array. Due to the difference of the components, the amplification factors, or the gains, of the vertical amplifiers are not identical, which results in the Fixed Pattern Noise in the image sensor. Various image processes may be performed according to the plurality images captured in sequence. In some embodiments, the dynamic range of the output image may thus be increased accordingly.

For example, in some embodiments, the electronic device 100 may be a smartphone, a tablet, a laptop or other electronic devices with a built-in digital camera device. In some other embodiments, the electronic device 100 may be applied in a virtual reality (VR)/mixed reality (MR)/augmented reality (AR) system. For example, the electronic device 100 may be realized by, a standalone head mounted device (HMD) or VIVE HMD. In detail, the standalone HMD may handle such as processing location data of position and rotation, graph processing or others data calculation.

As shown in FIG. 1, the electronic device 100 includes a processing circuit 110, a memory 120, a camera 130, a position sensor 140, an inertial measurement unit sensor 150, and an actuator 160. One or more programs PR1 are stored in the memory 120 and configured to be executed by the processing circuit 110, in order to perform various image processes.

In structural, the memory 120, the camera 130, the position sensor 140, the inertial measurement unit sensor 150, and the actuator 160 are respectively electrically connected to the processing circuit 110.

Specifically, the actuator 160 is connected to a lens 132 of the camera 130, in order to move the lens 132 according to a control signal received from the processing circuit 110. Thus, the relative position of the lens 132 to the camera 130 may be different during the operation. Variation of the position of the lens 132 may be detected by the position sensor 140 correspondingly. In some embodiments, the position sensor 140 may be implemented by one or more hall elements. By controlling the actuator 160 to adjust the position of the lens 132, the images taken by the camera 130 may be stable under motion, such as hand-shaking, head-shaking, vibration in the vehicle, etc. Accordingly, the Optical Image stabilization (OIS) may be achieved by the cooperation of the processing circuit 110, the inertial measurement unit sensor 150, and the actuator 160.

In some embodiments, the processing circuit 110 can be realized by, for example, one or more processors, such as central processors and/or microprocessors, but are not limited in this regard. In some embodiments, the memory 120 includes one or more memory devices, each of which includes, or a plurality of which collectively include a computer readable storage medium. The computer readable storage medium may include a read-only memory (ROM), a flash memory, a floppy disk, a hard disk, an optical disc, a flash disk, a flash drive, a tape, a database accessible from a network, and/or any storage medium with the same functionality that can be contemplated by persons of ordinary skill in the art to which this disclosure pertains.

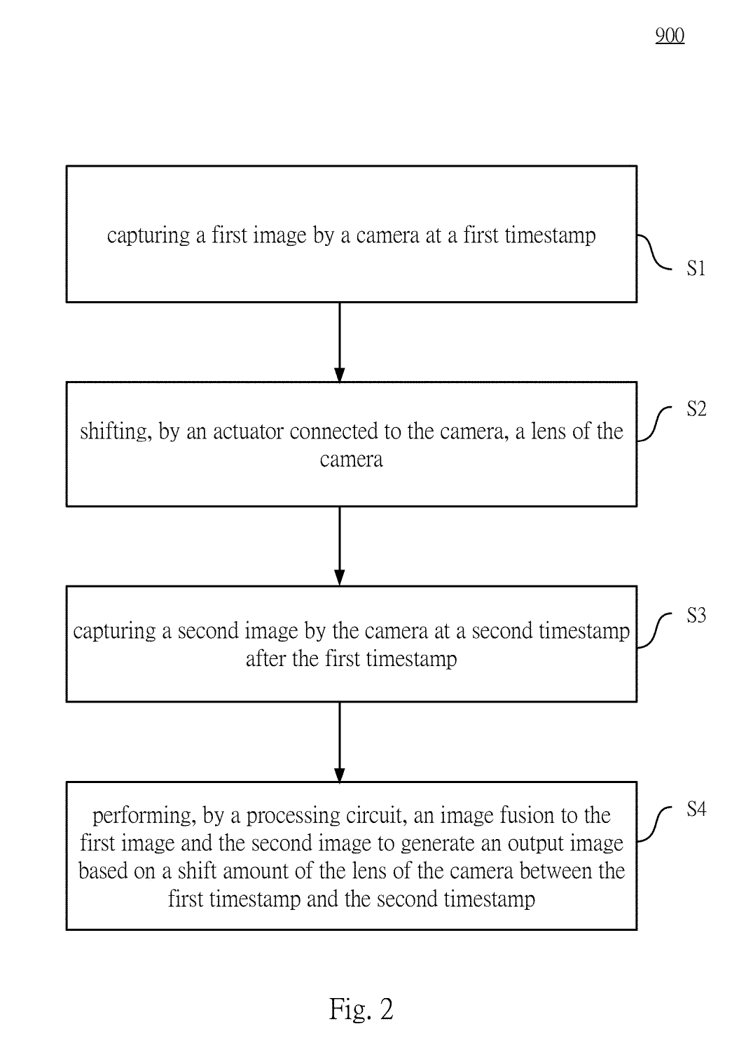

For better understanding of the present disclosure, the detailed operation of the electronic device 100 will be discussed in accompanying with the embodiments shown in FIG. 2. FIG. 2 is a flowchart illustrating an image processing method 900 in accordance with some embodiments of the present disclosure. It should be noted that the image processing method 900 can be applied to an electrical device having a structure that is the same as or similar to the structure of the electronic device 100 shown in FIG. 1. To simplify the description below, the embodiments shown in FIG. 1 will be used as an example to describe the image processing method 900 according to some embodiments of the present disclosure. However, the present disclosure is not limited to application to the embodiments shown in FIG. 1.

As shown in FIG. 2, the image processing method 900 includes operations S1, S2, S3, and S4. In operation S1, the processing circuit 110 is configured to control the camera 130 to capture a first image at a first timestamp. In some embodiments, during the operation S1, the processing circuit 110 may also be configured to control the position sensor 140 to obtain a first lens position indicating the location of the lens 132 at the first timestamp.

Specifically, in some embodiments, the processing circuit 110 may be configured to record a first environmental parameter at the first timestamp to indicate the environmental status of the first image. For example, the first environmental parameter may include a brightness parameter, a focus position parameter, a white balance parameter, histogram, an exposure time parameter, or any combinations thereof in the first image.

In operation S2, the processing circuit 110 is configured to control the actuator 160 to shift the lens 132 of the camera 130. Specifically, the processing circuit 110 may output a corresponding signal to a driving circuit of the actuator 160, such that the driving circuit drives the actuator 160 to shift along a horizontal direction and/or a vertical direction. That is, the shift amount and the shift direction may both be control and determined by the processing circuit 110. In some embodiments, the driving circuit may be implemented by the OIS controller, and the position of the lens 132 may be read back by the position sensor 140 to ensure the position accuracy.

In operation S3, the processing circuit 110 is configured to control the camera 130 to capture a second image at a second timestamp after the first timestamp. Similarly, in some embodiments, during the operation S3, the processing circuit 110 may also be configured to control the position sensor 140 to obtain a second lens position indicating the location of the lens 132 at the second timestamp. In some embodiments, the processing circuit 110 may be configured to record a second environmental parameter at the second timestamp to indicate the environmental status of the second image. Similar to the first environmental parameter, the second environmental parameter may also include a brightness parameter, a focus position parameter, a white balance parameter, histogram, an exposure time parameter, or any combinations thereof in the second image. In some embodiments, the first image captured at the first timestamp and the second image captured at the second timestamp are captured with different exposure times. That is, the exposure value may be different in two images.

Specifically, in some embodiments, the shift amount of the lens 132 of the camera 130 between the first timestamp and the second timestamp may be smaller than, equal to, or larger than a pixel between the first image and the second image. For example, the shift amount of the lens 132 of the camera 130 between the first timestamp and the second timestamp may be 0.5 pixel, 1 pixel, or 3 pixels. It is noted that the shift amounts mentioned above are merely by examples and not meant to limit the present disclosure.

In addition, in some embodiments, between the first timestamp and the second timestamp, the processing circuit 110 may be configured to control the inertial measurement unit sensor 150 to obtain an IMU signal. The IMU signal indicates a movement of the electronic device 100 between the first timestamp and a second timestamp. Alternatively stated, on the condition that the first image and the second image are taken by the camera 130 under motion, the processing circuit 110 may still perform calculation and control the shift direction and shift amount of the actuator 160 in order to obtain two images with desired different views.

Next, in operation S4, the processing circuit 110 is configured to perform an image fusion to the first image and the second image to generate an output image based on a shift amount of the lens 132 of the camera 130 between the first timestamp and the second timestamp. Specifically, in operation S4, the processing circuit 110 is configured to perform an image fusion to the first image and the second image to de-noise fixed pattern noises. Then, after the image fusion, the processing circuit 110 is configured to generate the output image based on the shift amount of the lens 132 of the camera 130 between the first timestamp and the second timestamp.

Specifically, in some embodiments, the image fusion may be performed to the first image and the second image based on the shift amount, the first environmental parameter, and the second environmental parameter. In some other embodiments, a motion sensor output, a vertical sync output obtained by the position sensor 140 or the inertial measurement unit sensor 150 may also be considered for the image fusion. In some other embodiments, various camera modes may be configured and selected by a user via a user interface, and different shift amounts or fusion setting may be applied in different camera modes correspondingly. For example, the image fusion performed to reduce the noise may be enable on the condition that the user taking the pictures in a zoom-in mode.

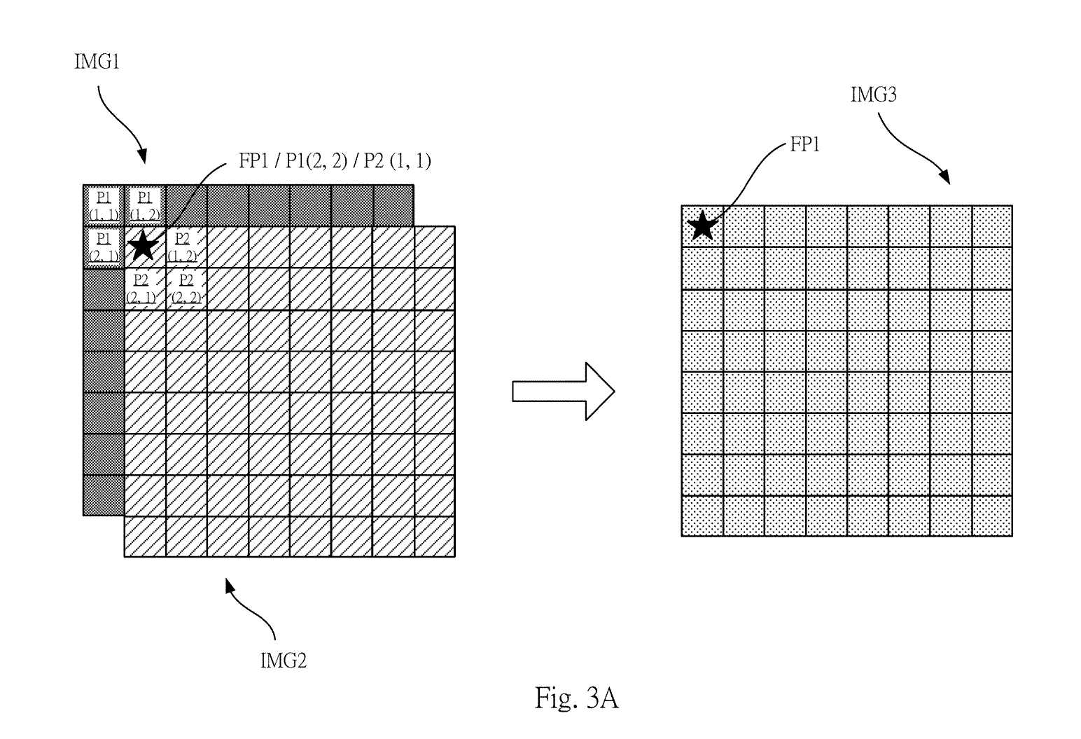

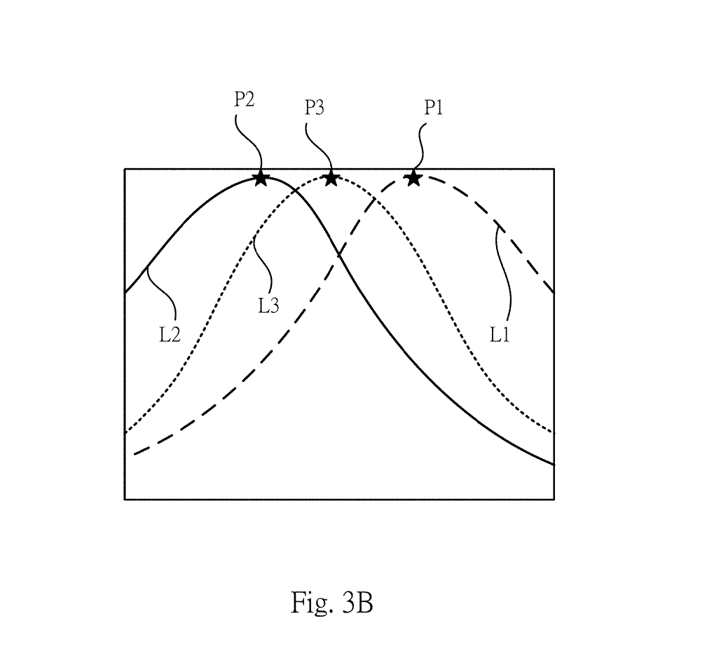

Reference is made to FIG. 3A. FIG. 3A is a diagram illustrating operation of the image processing method 900 according to some embodiments of the present disclosure. As shown in FIG. 3A, the camera 130 captured the first image IMG1 at the first timestamp, and the second image IMG2 at the second timestamp. The processing circuit 110 is configured to fuse the first image IMG1 and the second image IMG2 to generate and output the output image IMG3.

The shift amount of the lens 132 of the camera 130 between the first timestamp and the second timestamp in the vertical direction and in the horizontal direction are both equal to one pixel between the first image and the second image. Alternatively stated, the same feature point FP1 corresponding to a first pixel P1(2, 2) in the first image IMG1, is corresponding to a second pixel P2(1, 1) in the second image IMG2.

The processing circuit 110 may be configured to fuse the pixels P1(2, 2) and P2(1, 1) corresponding to the same feature point FP1 in the first image IMG1 and the second image IMG2. The above operation may also be applied to other pixels in the images, and thus further explanation is omitted for the sake of brevity. Thus, by fusing the pixels in two different images, the spatial noise and/or the temporal noise may be eliminated, since the two different images are captured in different views and in different times.

In some embodiments, the first image IMG1 is captured with a longer exposure time, therefore with a brighter exposure. On the other hand, the second image IMG2 is captured with a shorter exposure time, therefore with a darker exposure. Accordingly, the dynamic range of the output image IMG3 may be increased compared to the first image IMG1 and the second image IMG2 by taking the weighted average and by redistributing the histogram of the first image IMG1 and the second image IMG2.

Reference is made to FIG. 3B together. FIG. 3B is a diagram illustrating image histograms of the first image IMG1, the second image IMG2 and the output image IMG3 according to some embodiments of the present disclosure. In FIG. 3B, a curve L1 indicates tonal distribution of the first image IMG1, a curve L2 indicates tonal distribution of the second image IMG2, and a curve L3 indicates tonal distribution of the output image IMG3. The horizontal axis denotes the tonal value of the pixel, and the vertical axis denotes the occurrence percentage.

As depicted in FIG. 3B, by shifting the images, taking weighted average, and redistributing the histogram, the dynamic range of the output image IMG3 may be increased. For example, the point P1 denotes tonal value of the feature point FP1 in the first image IMG1 with brighter exposure, the point P2 denotes tonal value of the feature point FP1 in the second image IMG2 with darker exposure, and the point P3 denotes tonal value of the feature point FP1 in the output image IMG3 after image fusion with histogram compression and shifting.

Specifically, in some embodiments, in the operation S4, the processing circuit 110 is configured to calculate a weighted average of the first image IMG1 and the second image IMG2, and redistribute the histogram of the output image based on a first histogram of the first image and a second histogram of the second image. In some other embodiments, the processing circuit 110 may also be configured to perform various calculations to achieve and realize High Dynamic Range Imaging (HDR) with a single camera 130.

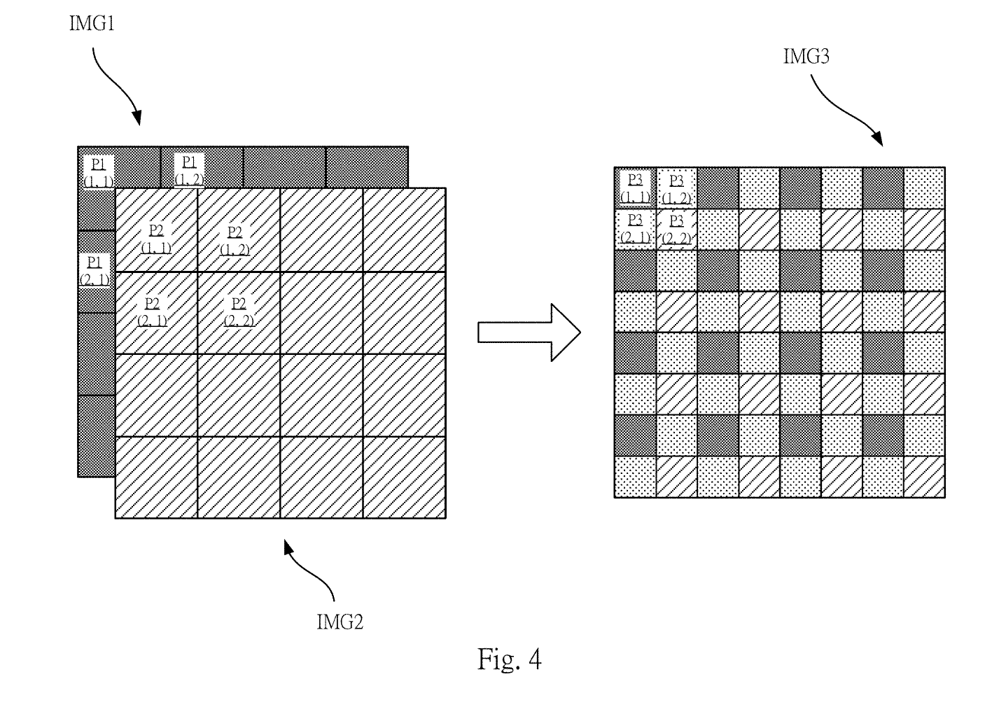

Reference is made to FIG. 4. FIG. 4 is a diagram illustrating operation of the image processing method 900 according to some other embodiments of the present disclosure. As shown in FIG. 4, similar to the embodiments shown in FIG. 3A, the camera 130 captured the first image IMG1 at the first timestamp, and the second image IMG2 at the second timestamp. The processing circuit 110 is configured to fuse the first image IMG1 and the second image IMG2 to generate and output the output image IMG3.

Compared to the embodiments of FIG. 3A, in the embodiments of FIG. 4, the shift amount of the lens 132 of the camera 130 between the first timestamp and the second timestamp in the vertical direction and in the horizontal direction are 0.5 pixel respectively between the first image and the second image. Alternatively stated, there is an overlap region R1 in a pixel P1(1, 1) of the first image IMG1 and a pixel P2(1, 1) of the second image IMG2.

The processing circuit 110 may be configured to perform an interpolation according to the first image IMG1 and the second image IMG2 to obtain the output image IMG3 to realize super-resolution. For example, the pixel P1(1, 1) of the first image IMG1 may be fused to the pixel P3(1,1), and the pixel P2(1, 1) of the second image IMG2 may be fused to the pixel P3(2,2), and the data of the pixel P3(1,2) and the pixel P3(2,1) may be calculated by the interpolation of the pixel P3(1,1) and the pixel P3(2,2). The above operation may also be applied to other pixels in the images, and thus further explanation is omitted for the sake of brevity.

Thus, by applying the super-resolution, a resolution of the output image IMG3 may be greater than the resolution of the first image IMG1 and of the second image IMG2.

Furthermore, as described in the above embodiments, the first image IMG1 may be captured with a longer exposure time, and the second image IMG2 may be captured with a shorter exposure time in order to increase the dynamic range of the output image IMG3 and realize High Dynamic Range Imaging (HDR) with a single camera 130. Alternatively stated, in the embodiments shown in FIG. 4, the spatial-temporal de-noise process, the High Dynamic Range Imaging process, and the super-resolution processing may be simultaneously realized though the single camera 130 with the OIS ability. The operation of the noise reduction and the High Dynamic Range Imaging are described in the above paragraphs in detail and thus further explanation is omitted for the sake of brevity.

It is noted that, in the operation S1 and the operation S3, the processing circuit 110 may be configured to control the actuator 160 to enable the optical image stabilization at the first timestamp and at the second timestamp. Accordingly, while taking the images, the Optical Image Stabilization system is still working to avoid the image blur results from the hand-shaking.

In addition, although the camera 130 is configured to capture two images in the embodiments stated above, the present disclosure is not limited thereto. In other embodiments, three or more images may be captured by the camera 130 in different timestamps and with different shift direction and/or amount in order to fuse the output image according to the sequentially captured images. By fusing the images, the fixed pattern noises such the Dark Signal Non-Uniformity (DSNU) noise and the Photo Response Non-Uniformity (PSNU) noise may be reduced and eliminated accordingly.

It should be noted that, in some embodiments, the image processing method 900 may be implemented as a computer program. When the computer program is executed by a computer, an electronic device, or the processing circuit 110 in FIG. 1, this executing device performs the image processing method 900. The computer program can be stored in a non-transitory computer readable storage medium such as a ROM (read-only memory), a flash memory, a floppy disk, a hard disk, an optical disc, a flash disk, a flash drive, a tape, a database accessible from a network, or any storage medium with the same functionality that can be contemplated by persons of ordinary skill in the art to which this disclosure pertains.

In addition, it should be noted that in the operations of the abovementioned image processing method 900, no particular sequence is required unless otherwise specified. Moreover, the operations may also be performed simultaneously or the execution times thereof may at least partially overlap.

Furthermore, the operations of the image processing method 900 may be added to, replaced, and/or eliminated as appropriate, in accordance with various embodiments of the present disclosure.

Through the operations of various embodiments described above, an image processing method is implemented to reduce spatial noise, temporal noise and/or fixed pattern noise of the captured image. In some embodiments, the image processing method may further be implemented to increase the dynamic range of the captured image, or increase the resolution of the image. The OIS function may be enabled during the process to reduce blurring of the images.

Although the present disclosure has been described in considerable detail with reference to certain embodiments thereof, other embodiments are possible. Therefore, the scope of the appended claims should not be limited to the description of the embodiments contained herein.

What is claimed is:

1. An image processing method comprising:
capturing a first image by a camera at a first timestamp;
shifting, by an actuator connected to the camera, a lens of the camera;
capturing a second image by the camera at a second timestamp after the first timestamp;
performing, by a processing circuit, an image fusion to the first image and the second image to de-noise fixed pattern noises; and
generating an output image based on a shift amount of the lens of the camera between the first timestamp and the second timestamp.

2. The image processing method of claim 1, further comprising:
recording, by the processing circuit, a first environmental parameter at the first timestamp;
recording, by the processing circuit, a second environmental parameter at the second timestamp; and
performing, by the processing circuit, the image fusion to the first image and the second image based on the shift amount, the first environmental parameter, and the second environmental parameter.

3. The image processing method of claim 1, further comprising:
enabling, by the actuator connected to the camera, an optical image stabilization at the first timestamp; and
enabling, by the actuator connected to the camera, the optical image stabilization at the second timestamp.

4. The image processing method of claim 1, wherein the shift amount of the lens of the camera between the first timestamp and the second timestamp is smaller than or equal to a pixel between the first image and the second image.

5. The image processing method of claim 1, further comprising:
calculating, by the processing circuit, a weighted average of the first image and the second image; and
redistributing, by the processing circuit, a histogram of the output image based on a first histogram of the first image and a second histogram of the second image.

6. The image processing method of claim 1, wherein the first image and the second image are captured with different exposure times.

7. The image processing method of claim 1, further comprising:
performing, by the processing circuit, an interpolation according to the first image and the second image to obtain the output image, wherein a resolution of the output image is greater than the resolution of the first image and of the second image.

8. The image processing method of claim 1, wherein the fixed pattern noises comprises a dark signal non-uniformity (DSNU) noise, a photo response non-uniformity (PSNU) noise, or a combination thereof.

9. An electronic device, comprising:
a processing circuit;
a camera electrically connected to the processing circuit;
an actuator electrically connected to the camera;
a memory electrically connected to the processing circuit; and
one or more programs, wherein the one or more programs are stored in the memory and configured to be executed by the processing circuit, the one or more programs comprising instructions for:
controlling the camera to capture a first image at a first timestamp;
controlling the actuator to shift a lens of the camera;
controlling the camera to capture a second image at a second timestamp after the first timestamp;
performing an image fusion to the first image and the second image to de-noise fixed pattern noises; and
generating an output image based on a shift amount of the lens of the camera between the first timestamp and the second timestamp.

10. The electronic device of claim 9, wherein the one or more programs further comprise instructions for:
recording a first environmental parameter at the first timestamp;
recording a second environmental parameter at the second timestamp; and
performing the image fusion to the first image and the second image based on the shift amount, the first environmental parameter, and the second environmental parameter.

11. The electronic device of claim 9, wherein the one or more programs further comprise instructions for:
controlling the actuator to enable an optical image stabilization at the first timestamp; and
controlling the actuator to enable the optical image stabilization at the second timestamp.

12. The electronic device of claim 9, wherein the shift amount of the lens of the camera between the first timestamp and the second timestamp is smaller than or equal to a pixel between the first image and the second image.

13. The electronic device of claim 9, wherein the one or more programs further comprise instructions for:
calculating a weighted average of the first image and the second image; and
redistributing a histogram of the output image based on a first histogram of the first image and a second histogram of the second image.

14. The electronic device of claim 9, wherein the first image and the second image are captured with different exposure times.

15. The electronic device of claim 9, wherein the one or more programs further comprise instructions for:
performing an interpolation according to the first image and the second image to obtain the output image, wherein a resolution of the output image is greater than the resolution of the first image and of the second image.

16. A non-transitory computer readable storage medium storing one or more programs, comprising instructions, which when executed, causes a processing circuit to perform operations comprising:
controlling a camera to capture a first image at a first timestamp;
controlling an actuator electrically connected to the camera to shift a lens of the camera;
controlling the camera to capture a second image at a second timestamp after the first timestamp;
performing an image fusion to the first image and the second image to de-noise fixed pattern noises; and
generating an output image based on a shift amount of the lens of the camera between the first timestamp and the second timestamp.

17. The non-transitory computer readable storage medium of claim 16, further comprising instructions, which when executed, causes the processing circuit to further perform operations comprising:
recording a first environmental parameter at the first timestamp;
recording a second environmental parameter at the second timestamp; and
performing the image fusion to the first image and the second image based on the shift amount, the first environmental parameter, and the second environmental parameter.

18. The non-transitory computer readable storage medium of claim 16, further comprising instructions, which when executed, causes the processing circuit to further perform operations comprising:
controlling the actuator to enable an optical image stabilization at the first timestamp; and
controlling the actuator to enable the optical image stabilization at the second timestamp.

19. The non-transitory computer readable storage medium of claim 16, further comprising instructions, which when executed, causes the processing circuit to further perform operations comprising:
calculating a weighted average of the first image and the second image; and
redistributing a histogram of the output image based on a first histogram of the first image and a second histogram of the second image.

20. The non-transitory computer readable storage medium of claim 16, further comprising instructions, which when executed, causes the processing circuit to further perform operations comprising:
performing an interpolation according to the first image and the second image to obtain the output image, wherein a resolution of the output image is greater than the resolution of the first image and of the second image.
